(19) United States
(12) Patent Application Publication
(10) Pub. No.: US 2026/0112345 A1
(43) Pub. Date: Apr. 23, 2026

(54) MUSIC SERVICE FOR THE DETECTION OF COPYRIGHT INFRINGEMENT

(71) Applicant: George Sullivan, Scarborough, ME (US)

(72) Inventor: George Sullivan, Scarborough, ME (US)

(21) Appl. No.: 19/428,200

(22) Filed: Dec. 21, 2025

Related U.S. Application Data
(63) Continuation-in-part of application No. 19/315,996, filed on Sep. 2, 2025.
Application No. 19/315,996 is a continuation of application No. 18/116,469, filed on Mar. 2, 2023, now Pat. No. 12,406,644.
(60) Provisional application No. 63/409,358, filed on Sep. 23, 2022.

(51) Int. Cl. G10H 1/00; G06F 21/10

(52) U.S. Cl. CPC G10H 1/0025; G06F 21/1015

(57) ABSTRACT

A system comprises one or more processors and one or more memories storing instruction code that, when executed, causes the system to receive audio content from one or more content sources, the audio content including a plurality of audio compositions. For each audio composition, the system identifies one or more stems that represent individual instrumental or vocal components and generates, for both the full composition and the identified stems, a plurality of interpolated stem variants by applying a defined set of pitch adjustments and a defined set of tempo adjustments. The system stores the interpolated variants for the plurality of audio compositions in an interpolation database, receives suspect content to be evaluated for infringement, and compares the suspect content against at least a portion of the interpolated variants stored in the interpolation database to determine whether the suspect content matches any of the interpolated variants. Based on any detected match, the system determines an appropriate action to take, including reporting a match outcome, permitting or blocking distribution of the suspect content, or preparing material for rights registration.

### CROSS-REFERENCE TO RELATED APPLICATIONS

This application is a continuation-in-part of U.S. patent application Ser. No. 19/315,996, filed Sep. 2, 2025, which is a continuation of U.S. patent application Ser. No. 18/116,469, filed Mar. 2, 2023, now U.S. Pat. No. 12,406,644 B2, which claims the benefit of priority of Provisional Patent Application 63/409,358 titled “Music Service for the Detection of Copyright Infringement,” filed on Sep. 23, 2022. The entire content of these applications is incorporated herein by reference in its entirety.

### BACKGROUND

### A. Technical Field

The present invention relates, in general, to services for intellectual property protection, and, more particularly, but without limitation, to a music service for the detection of copyright infringement.

Music composition analysis and adjustment is known in the art. U.S. Pat. No. 5,496,962 discloses a system for real-time music composition and synthesis. U.S. Pat. No. 7,076,035 discloses methods for providing on-hold music using auto-composition. U.S. Pat. No. 7,102,069 discloses systems and methods for creating, modifying, interacting with and playing musical compositions. US 2018/0082606 discloses an apparatus to detect, analyze, record, and display audio data, and method thereof. While there is software that is able to detect infringement of copyrighted music, people routinely alter the speed and pitch of copyrighted music as to avoid detection while on platforms such as YouTube.

However, none of the art addresses an automated process for detecting copyright infringement of music by transformative analysis of a song or video performance.

### B. Copyright Notice

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

In a first aspect, a system comprises one or more processors and one or more memories storing instruction code that, when executed, causes the system to receive audio content from one or more content sources, the audio content including a plurality of audio compositions. For each audio composition, the system identifies one or more stems that represent individual instrumental or vocal components and generates, for both the full composition and the identified stems, a plurality of interpolated stem variants by applying a defined set of pitch adjustments and a defined set of tempo adjustments. The system stores the interpolated variants for the plurality of audio compositions in an interpolation database, receives suspect content to be evaluated for infringement, and compares the suspect content against at least a portion of the interpolated variants stored in the interpolation database to determine whether the suspect content matches any of the interpolated variants. Based on any detected match, the system determines an appropriate action to take, including reporting a match outcome, permitting or blocking distribution of the suspect content, or preparing material for rights registration.

In a second aspect, a non-transitory computer-readable storage medium stores instruction code that, when executed by one or more processors, causes a system to receive audio content from one or more content sources, the audio content comprising a plurality of audio compositions. For each audio composition, the instruction code causes the system to identify one or more stems that represent individual instrumental or vocal components and to generate, for both the full composition and the identified stems, a plurality of interpolated stem variants by applying a defined set of pitch adjustments and a defined set of tempo adjustments. The instruction code further causes the system to store the interpolated variants for the plurality of audio compositions in an interpolation database, to receive suspect content for infringement analysis, to compare the suspect content against at least a portion of the interpolated variants stored in the interpolation database to determine whether the suspect content matches any of the interpolated variants, and to determine an action based on any detected match, the action comprising reporting a match outcome, permitting or blocking distribution of the suspect content, or preparing material for rights registration.

In a third aspect, a computer-implemented method comprises receiving, from one or more content sources, audio content comprising a plurality of audio compositions; for each audio composition of the plurality of audio compositions, identifying one or more stems of the audio composition and generating, for the audio composition and for the identified stems, a plurality of interpolated stem variants by applying a set of pitch adjustments and a set of tempo adjustments; storing the interpolated variants for the plurality of audio compositions in an interpolation database; receiving suspect content for infringement analysis; comparing the suspect content to at least a portion of the interpolated variants stored in the interpolation database to determine whether the suspect content matches one or more of the interpolated variants; and determining an action to take based on the match, the action comprising reporting a match outcome, permitting or blocking distribution of the suspect content, or preparing material for rights registration.

The foregoing summary is illustrative only and is not intended to be in any way limiting. In addition to the illustrative aspects and features described above, further aspects and features will become apparent by reference to the drawings and the following detailed description.

Other systems, methods, features, and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 shows components of a computing environment for detecting infringement of an audio composition, in accordance with example embodiments.

FIG. 2 shows a client computer for detecting infringement of an audio composition, in accordance with example embodiments.

FIG. 3 shows a network computer that may at least partially implement one of the various aspects for detecting infringement of an audio composition, in accordance with example embodiments.

FIG. 4 illustrates a block diagram of a system for detecting an infringing audio composition, in accordance with example embodiments.

FIG. 5 illustrates a flowchart for acts taken in an exemplary method for detecting copyright infringement, in accordance with example embodiments.

FIG. 6 illustrates a flowchart for acts taken in an exemplary method for detecting an infringed audio composition, in accordance with example embodiments.

FIG. 7 illustrates audio-variant generation and organization logic, in accordance with example embodiments.

FIG. 8 illustrates infringement-analysis logic, according to an aspect of the disclosure.

FIG. 9 illustrates operations for generating interpolated variants of a plurality of audio compositions and preparing those variants for downstream processing, in accordance with example embodiments.

FIG. 10 illustrates operations for performing infringement analysis using the interpolation database and suspect content, in accordance with example embodiments.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

The elements in the Figures interoperate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

In the following description, numerous specific details are set forth to clearly describe various specific aspects disclosed herein. One skilled in the art, however, will understand that the presently claimed invention may be practiced without all of the specific details discussed below. In other instances, well known features have not been described so as not to obscure the invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, it should be understood that aspects of the invention include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the invention may be implemented in software. As such, it should be noted that a plurality of hardware and software-based devices, as well as a plurality of different structural components may be utilized to implement the invention. Furthermore, and as described in subsequent paragraphs, the specific mechanical configurations illustrated in the drawings are intended to exemplify aspects of the invention and that other alternative mechanical configurations are possible.

### A. Introduction

According to some aspects, the presently disclosed system and/or method may take an original composed musical composition and generate multiple incrementally adjusted versions by pitch, tempo, and/or key. These adjusted versions may be used for detection, comparison, cataloging, rights management, or submission to external systems such as the Library of Congress, Shazam, or YouTube's music identification services, among others.

The process to manually alter a song to the most common ranges of tempos and pitches to detect infringement is a long and arduous process. The automation of this process saves extensive amounts of time and helps solve the problem of copyright infringement of digital music by quickly being able to detect clever infringers.

The following briefly describes the aspects of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

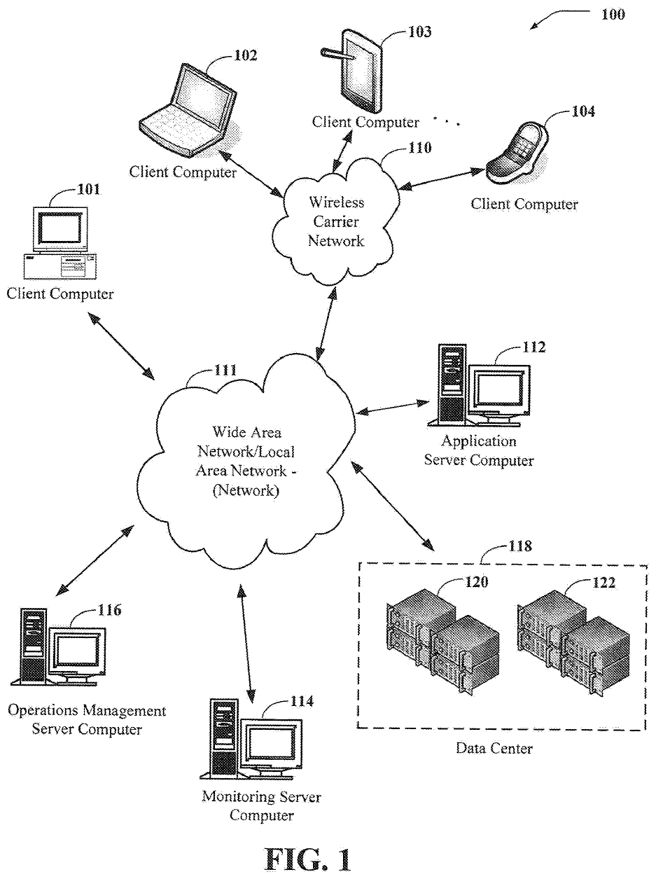

FIGS. 1-3 correspond to computing environments, client-computer architectures, and server-computer architectures of the type described in U.S. Pat. No. 12,406,644 B2, issued Sep. 2, 2025, from which this application claims priority. The figures included here illustrate example configurations usable with the systems and methods described herein, and further aspects, alternatives, and implementation details of these components are described in the parent patent.

FIG. 1 illustrates an example computing environment 100 in which the audio-processing and infringement-detection system may operate. The environment 100 includes multiple client computers 101, 102, 103, and 104, which may represent desktop, laptop, tablet, or mobile devices.

The client computers 101-104 communicate through a wireless network 110 and a network 111 that may include local-area or wide-area networking resources. The environment further includes an application server computer 112, a monitoring server computer 114, and an operations-management server computer 116, which may together implement ingestion, analysis, stem-processing, and rights-management workflows.

These server systems may be deployed within or associated with a data center 118 that includes enclosure 120 and enclosure 122, which may represent racks or groups of physical or virtual machines. The particular arrangement of the computing environment 100 is non-limiting and may vary.

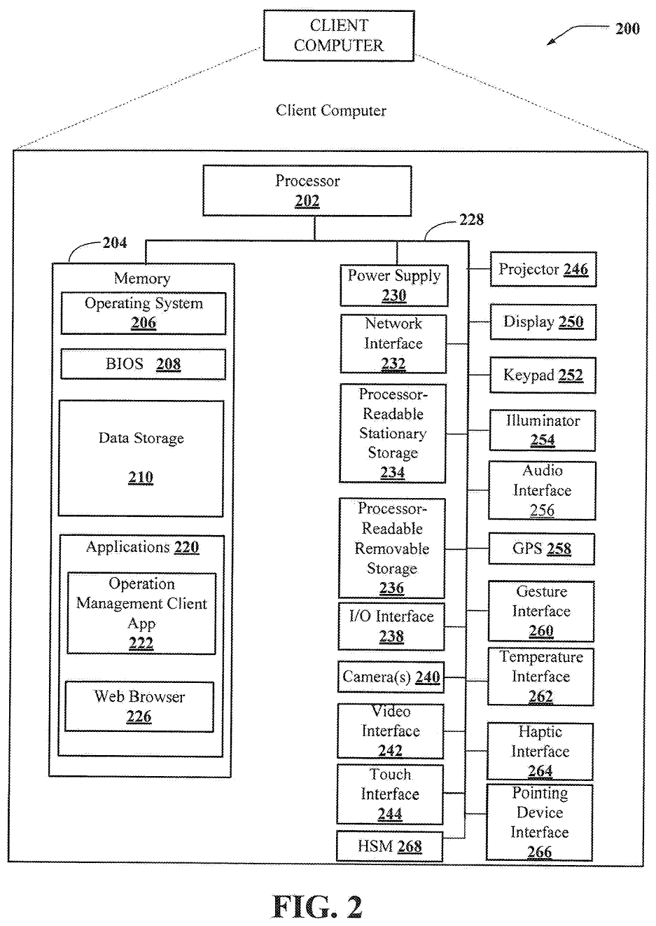

FIG. 2 illustrates an example client computer 200, which may correspond to any of the client computers 101-104 in FIG. 1. The client computer 200 includes a processor 202 coupled to a memory 204, which may store an operating system 206, a BIOS 208, data storage 210, and one or more applications 220, including an operations-management client application 222 and an optional web browser 226. Components within the client computer 200 may communicate over a bus 228, and a power supply 230 delivers electrical power. The device may further include a network interface 232 for communication, stationary storage 234, removable storage 236, and an I/O interface 238 for peripherals.

The client computer 200 may also include user-interface and sensor components such as a camera 240, a video interface 242, a touch interface 244, a projector 246, a display 250, a keypad 252, an illuminator 254, an audio interface 256, a GPS receiver 258, an open-air gesture interface 260, a temperature interface 262, a haptic interface 264, and a pointing-device interface 266.

In some examples, the client computer 200 includes a hardware security module (HSM) 268 for secure storage of cryptographic information. Any subset or combination of these components may be used.

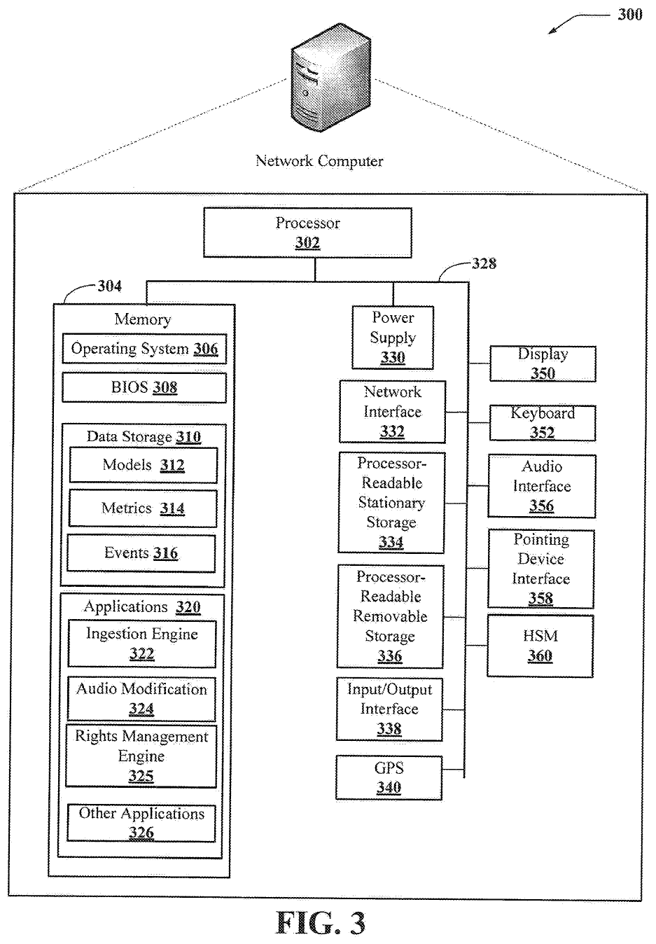

FIG. 3 illustrates an example network computer 300 that may implement server-side functionality for ingestion, interpolation, stem analysis, or rights-management logic. The network computer 300 includes a processor 302, a memory 304, and storage components including data storage 310, stationary storage 334, and removable storage 336, all coupled via a bus 328. A power supply 330 provides electrical power to the network computer 300.

The memory 304 may store an operating system 306, a BIOS 308, and stored information such as models 312, metrics 314, and events 316. The network computer 300 may execute applications 320 including an ingestion engine 322, an audio-modification engine 324, a rights-management engine 325, and other applications 326 that support overall system operation.

Additional components may include a network interface 332, an input/output interface 338, a display 350, a keyboard 352, an audio interface 356, and a pointing-device interface 358. Optional modules may include a GPS receiver 340 and a hardware security module (HSM) 360. Multiple instances of the network computer 300 may be deployed within the data center 118 shown in FIG. 1.

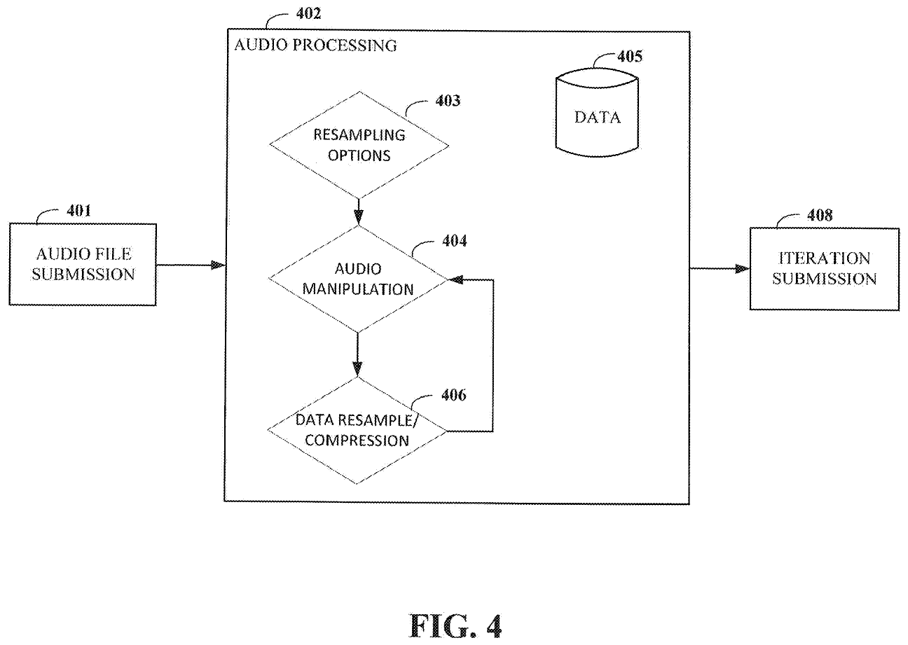

FIG. 4 illustrates an exemplary block diagram of a system for detecting an infringing audio composition, according to an aspect of the disclosure. The system includes an audio file submission or ingestion engine 401, where a digital music file, such as an original audio recording submitted by a user, is provided to the system. The audio file is transferred to the audio processing engine 402. At an audio resampling options engine 403, the system may select sampling/resampling options for processing the audio, either through pre-selected options or user-selected options.

An audio manipulation engine 404 may be used to adjust and/or modify pitch, tempo, and/or key of the digital audio music file. An example process flow for the audio manipulation engine 404 is described herein. The system may evaluate an original audio recording of the input digital music file, an instrumental version of the input digital music file, and an acapella version of the input digital music file. The instrumental version and the acapella version may be created from the original audio recording using conventional audio processing techniques known to one of skill in the art, using digital audio sampling and/or manipulation of the original audio recording.

In some examples, the system may manipulate the original audio recording, acapella version, and/or instrumental version of the input digital music file or audio composition by changing a pitch of the original audio recording by a number of pitch steps, for example by slowing down or speeding up the original audio recording. A key and a tempo of the original audio recording may rise together incrementally to create a number of altered pitch versions, or processed iterations, corresponding to the pitch steps of the original audio recording, acapella version, and/or instrumental version in one direction (such as a higher pitch) and a second number of altered pitch versions in another direction (such as a lower pitch). The number of altered pitch versions or processed iterations may be selected as desired by the user for convenience and manageability of computation. In some examples, the number of altered pitch versions may be 10 in each direction. As the pitch changes, the key of the original audio recording may change together with the tempo.

In some examples, the system may generate pitch-shifted versions spanning up to two octaves above and two octaves below the original pitch. In Western tonal systems, each octave corresponds to twelve semitone steps; accordingly, a shift of two octaves in each direction yields up to forty-eight semitone increments, plus the original version, resulting in approximately forty-nine pitch-shifted versions of the source material.

In some examples, the system may generate each of these pitch-shifted versions in half-step (semitone) increments, ensuring a musically complete range of possible transpositions. These semitone-increment transpositions may be used for generating full-mix variants and/or stem-specific variants, and may further support downstream comparison, detection submission, and rights-registration workflows.

In some examples, the system may manipulate the original audio recording, acapella version, and/or instrumental version by changing a key of the original audio recording, while keeping the tempo the same. The key may be incremented higher in one direction by key steps, then decremented lower in another direction by key steps. Each increment results in an altered key version. In some examples, the system will create 12 altered key versions in one direction (corresponding to an octave) and 12 altered key versions in a second direction.

In some examples, the system may manipulate the original audio recording, acapella version, and/or instrumental version by changing a tempo of the original audio recording while keeping the key the same. The system may increase the tempo incrementally in a first number of tempo steps and decrease the tempo incrementally in a second number of tempo steps. In some examples, both numbers of steps may be 10.

In some examples, the system may vary the tempo of the original audio recording, acapella version, and/or instrumental version in fixed beats-per-minute (BPM) increments, for example in increments of approximately 3 BPM. In some examples, the system may generate twenty or more tempo-adjusted versions for each pitch level, with corresponding increases and decreases relative to the source tempo. The magnitude of tempo variation and the number of incremental steps may be selected based on the musical content, original BPM, or detection-coverage requirements.

In some examples, when generating tempo variants, the system may maintain the pitch and/or musical key constant such that, for each pitch-shifted version of the recording, a set of multiple tempo-adjusted variants is created. For example, if a pitch-shifted version corresponds to a transposition into the key of A, the system may generate a set of twenty or more tempo-skewed variants that all remain in the key of A while exhibiting differing BPM values.

In some examples, the system may incrementally change the key of the original audio recording by a key step, and then adjust the tempo of the original audio recording in a tempo slide as the tempo slows down and speeds up in a number of tempo steps in each direction. The system will then change the pitch again to a next key and repeat the tempo slide. Thus, for each key step up and key step down, there may be a corresponding number of tempo slide levels. In some examples, the system may create 12 key up steps and 12 key down steps, with 10 versions of the tempo rising and falling in each direction.

A database 405 may be operatively connected to the audio processing engine 402. The database 405 may be contained within the audio processing engine 402, located remotely, or distributed across multiple network devices. The database 405 may store audio files, digital rights management files, software code, audio and signal processing parameters, audio repositories, or rendered digital audio tracks. In some examples, the database 405 may save iterations using GPL and/or FOS software libraries.

During audio manipulation, the system may also determine updated resampling options and/or compression options through a data resample/compression engine 406. The options from the engine 406 may be fed back into the audio manipulation engine 404 for additional processing or evaluation. In some examples, the system may allocate additional processing power to the audio manipulation engine 404.

For each version or iteration, the system evaluates pitch and tempo. The processed iteration may be submitted to an iteration submission engine 408 to automatically search for an original version or an oldest known published version from one or more music identification services or digital rights repositories (for example, YouTube, Shazam, the Library of Congress, or the Mechanical Licensing Collective (MLC)). If the comparison yields a match, the service may identify the match as a possible infringement.

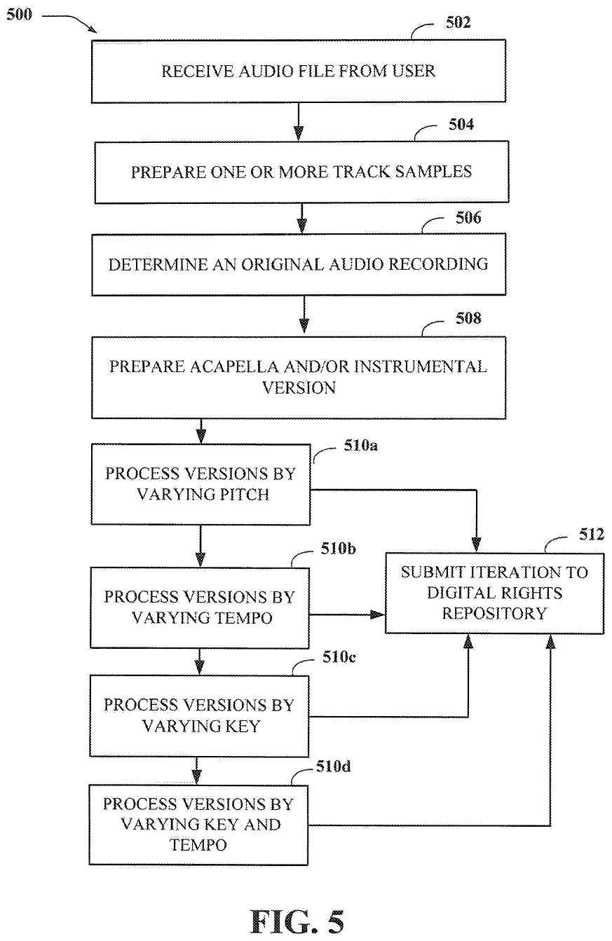

FIG. 5 illustrates a flowchart 500 for acts taken in an exemplary method for detecting an infringed audio composition. FIG. 5 is explained in conjunction with FIG. 1 to FIG. 4. The control starts at act 502.

At act 502, the system receives and/or ingests an audio file from a user. The user may be a member of, a client of, or registered with a digital rights enforcement service or entity that makes use of the disclosed system to detect a copyright infringed audio composition. In an aspect, the audio file may an original audio recording, live performance, recorded performance or other types of audio files known in the art. The audio file may be of an MPG, WAV, FLAC, OOG or other audio file formats known to one of skill in the art. The audio file may be compressed with lossy or lossless compression. In an aspect, the audio file may be later manipulated and/or processed with compression routines to allow more options for a user and the system to process the audio file, including resampling options.

At act 504, the system may prepare one or more track samples based on the received audio file to compare with one or more audio files stored with a digital rights repository, such as Shazam, YouTube, the Library of Congress or other digital music and digital rights repositories. The system may create a number of track samples (20) for comparison against the digital rights repository. In an aspect, the number of track samples may be approximately 20. In an aspect, each separate track is individually run against a service such as Shazam (https://github.com/dotX12/ShazamIO) with a definable search query of release date, match percentage, lyrics and/or instrumental renditions.

At act 506, the system determines an original audio recording from the digital rights repository based on the one or more track samples.

At act 508, the system prepares an acapella version based on the original audio recording and/or an instrumental version based on the original audio recording.

At acts 510a-510d, the system processes, by iteratively varying a pitch (act 510a), a tempo (act 510b) and/or a key (510c), and/or a key and tempo at the same time (act 510d) of, the original audio recording, the acapella version and/or the instrumental version to create a processed iteration of each of the original audio recording, the acapella version and/or the instrumental version. In an aspect, the system may iteratively vary the pitch of the original audio recording, the acapella version and/or the instrumental version by a number of pitch steps. In an aspect, the number of pitch steps may be 10 steps in both directions of key. In an aspect, the system may iteratively vary the tempo of the original audio recording, the acapella version and/or the instrumental version by a number of tempo steps. In an aspect, the number of tempo steps may be 10 steps in both directions of tempo speed. In an aspect, the system may iteratively vary the key of the original audio recording, the acapella version and/or the instrumental version by a number of key steps. In an aspect, the number of key steps may be 12 steps in both directions of key. In an aspect, the system would incrementally change the key by a note, and then do a tempo slide of that song as the tempo slows down and speeds up 10 different versions of each way (act 510d). Then, the system would change the pitch again to the next key, and do the same thing with the tempo. Essentially, at each key 12 up and 12 down there would be 10 versions of the tempo rising and falling in each direction, giving 20 different versions of 24 different keys.

In some examples, the pitch-variation and tempo-variation operations described above may be performed not only independently but also in combination to generate a large set of pitch—tempo pairs. For each semitone-increment pitch level produced during act 510a, the system may further generate the multiple BPM-increment tempo variants described in act 510b, thereby producing a multidimensional set of manipulated versions. These combinations may span all available pitch shifts and all available tempo increments, resulting in a comprehensive set of interpolated versions usable for detection, comparison, or rights-registration workflows.

In some examples, the pitch-and-tempo combinations produced by the system may collectively simulate a broad range of likely transformations applied during unauthorized derivative works, remixes, edits, time-stretching, or pitch-shifting. Generating these interpolated versions in advance enables the system to identify potential matches more reliably when submitting versions to external music-identification services, digital-fingerprinting databases, or copyright-registration repositories.

In an aspect, during audio manipulation, the system may also determine updated resampling options and/or compression options through the data resample/compression engine 406. The options from data resample/compression engine 406, either input by a user or provided based on the audio file data, or drawn from the database 405, may be fed back into the audio manipulation engine for additional processing or evaluation of processed iterations of the original audio recording, the acapella version and/or the instrumental version.

At act 512, the system will automatically submit each processed iteration of the audio compositions to compare the processed iteration of each of the original audio recording, the acapella version and/or the instrumental version with the one or more audio files stored with a digital rights repository. The automatic submission of each iteration reduces the computational load of uploading the entire set of processed iterations to a digital rights repository such as Shazam or YouTube music identification to determine a match by comparison between the processed iterations and the audio files stored in the digital rights repository. In an aspect, for each version or iteration, the system will then evaluate a pitch and a tempo of the version. In an aspect, the processed iteration is sampled and submitted to an iteration submission engine 408 to automatically search for an original version or an oldest known published version, from one or more music identification software services or digital rights repository (such as YouTube, Shazam, the Library of Congress, the Mechanical Licensing Collective (MLC) or other digital rights services or entities) to compare the one or more digital audio tracks with different processed iterations to one or more existing digital music files. According to some aspects, if the comparison yields a match, the one or more music identification software services may identify the match as possible infringement.

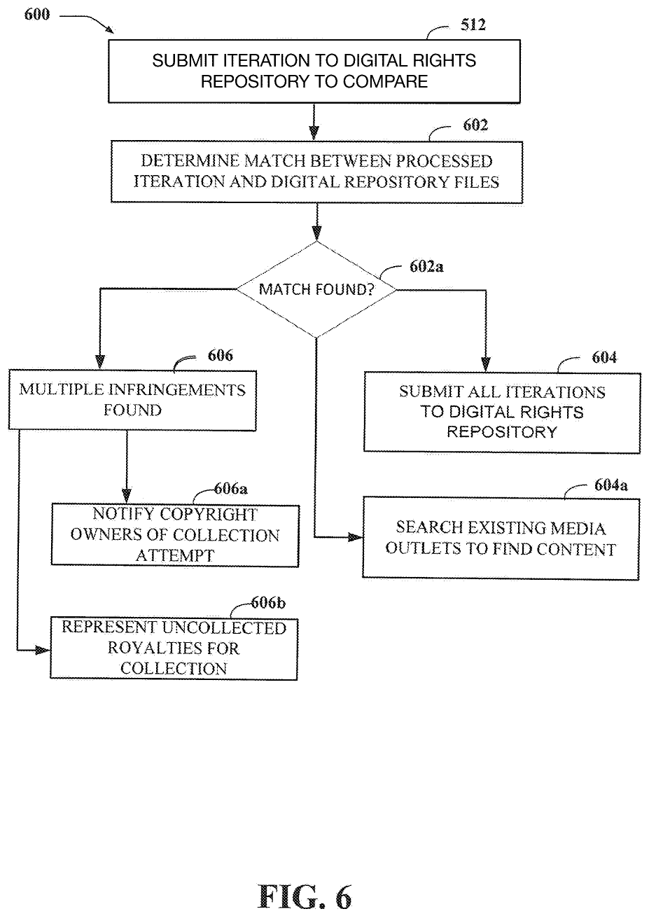

FIG. 6 illustrates a flowchart 600 for acts taken in an exemplary method for detecting an infringed audio composition continuing from the acts illustrated in FIG. 5. Processing begins at act 512.

At act 602, the system determines if a match between the processed iteration of each of the original audio recording, the acapella version and/or the instrumental version and the one or more audio files stored with the digital rights repository exists. The system may determine the match by determining one or more copyright infringing matches based on the one or more audio files stored with the digital rights repository.

At act 602a, the system determines, based on the match, what responses to take as a digital rights action to preserve intellectual property protection and enforcement of copyrighted material such as the original audio recording or audio composition. The system determines a digital rights action to take based on the match between the processed iteration of each of the original audio recording, the acapella version and/or the instrumental version and the one or more audio files stored with the digital rights repository.

At act 604, the system may determine the digital rights action by, responsive to determining there is no match between the processed iteration of each of the original audio recording, the acapella version and/or the instrumental version and the one or more audio files stored with the digital rights repository, automatically submitting all or a portion of the processed iterations of each of the original audio recording, the acapella version and/or the instrumental version for registration with a digital rights agency, such as the Library of Congress, MLC or other digital copyright services and entities, for registration with these entities or services.

At act 604a, if no match is determined at act 602, the system may also search a media outlet for a match to the processed iteration of each of the original audio recording, the acapella version and/or the instrumental version. The system may use the unmatched iterations to protect original content from a missed content ID match.

At act 606, the system determines that multiple infringing audio compositions have been detected. Each infringement of a processed iteration of the original audio recording, the acapella version and/or the instrumental version is accounted for.

At act 606a, the system may determine the digital rights action by, responsive to determining there is more than one match between the processed iteration of each of the original audio recording, the acapella version and/or the instrumental version and the one or more audio files stored with the digital rights repository (multiple infringements), notifying a digital rights (copyright) holder of a royalty collection.

At act 606b, the system may determine the digital rights action by, responsive to determining there is more than one match between the processed iteration of each of the original audio recording, the acapella version and/or the instrumental version and the one or more audio files stored with the digital rights repository (multiple infringements), representing uncollected royalties for collection. In an aspect, if the artist of the original audio recording is represented by the system provider or licensee, the royalty collection is represented. In an aspect, if the outcome from act 604a, searching a media outlet for a match to the processed iteration(s) results in a match, then the system may process act 606b to represent uncollected royalties for collection.

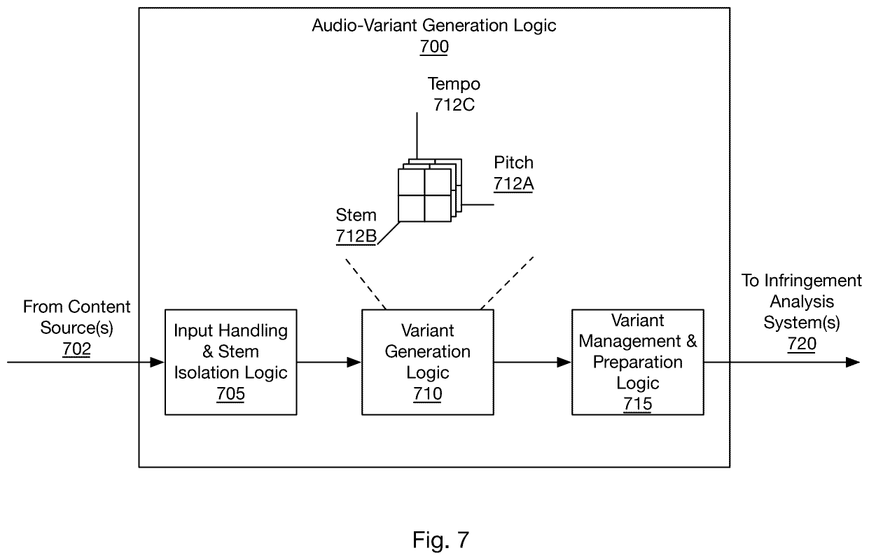

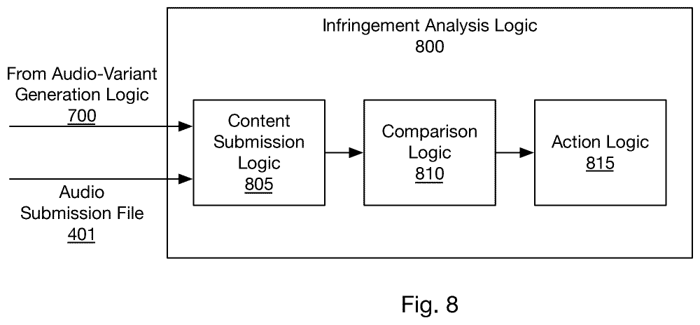

FIGS. 7 and 8 illustrate additional examples of architectures that may be used with the systems and methods described herein. In some examples, the architectures provide logic that generates, organizes, submits, and evaluates large sets of audio variants, including full-mix variants and stem-specific variants. As used herein, a full-mix refers to a complete audio program or finished musical mix that includes all musical elements combined into a single recording (for example, vocals, drums, bass, guitars, keyboards, effects, ambient layers, etc.). A stem refers to an isolated musical component or submix that represents one element or group of elements from the full-mix (for example, an isolated vocal line, an isolated drum track, an isolated bass track, a harmonic or chord-instrument layer, an effects layer, etc.).

In some examples, the audio-variant generation and organization logic 700 of FIG. 7 receives audio content comprising a plurality of audio compositions from one or more content sources 702—such as creator-submitted uploads, distribution-platform feeds, multitrack delivery systems, partner-platform ingestion services, or catalog-synchronization interfaces—and, for each audio composition, generates pitch-, key-, and tempo-based variants (including stem-specific interpolations and full-mix interpolations). The audio-variant generation and organization logic 700 communicates selected variants together with associated metadata to infringement-analysis logic 800. In some examples, the infringement-analysis logic 800 of FIG. 8 receives the variants communicated by the audio-variant generation and organization logic 700 and also receives a suspect audio submission 401 (for example, a user-uploaded track, a streaming-platform upload attempt, or other audio content to be evaluated for infringement). The infringement-analysis logic 800 compares the suspect audio submission 401 to the variants generated by the audio-variant generation and organization logic 700 and determines an appropriate action to take—such as reporting a match outcome, confirming or rejecting suspected infringement, allowing or blocking an upload, or preparing materials for rights-registration workflows.

FIG. 7 illustrates example audio-variant generation and organization logic 700. The audio-variant generation and organization logic 700 includes input-handling and stem-isolation logic 705, variant-generation logic 710, and variant-management and preparation logic 715. The audio-variant generation and organization logic 700 receives audio content from one or more content sources 702—such as content-creator uploads, distribution-platform libraries, copyright-holder repositories, multitrack-bundle delivery systems, or ingestion interfaces exposed by digital-rights partners—and generates pitch-, key-, and tempo-adjusted variants, including variants generated from isolated stems. The audio-variant generation and organization logic 700 communicates selected variants and associated metadata to one or more infringement-analysis systems 720 for downstream matching, fingerprinting, or rights-registration workflows.

Some examples of the audio-variant generation and organization logic 700 receive and process a plurality of audio compositions rather than a single work. In these examples, the logic 700 iterates through each audio composition provided by the content sources 702, identifies stems for each audio composition, generates pitch- and tempo-interpolated variants for each identified stem, and accumulates the variants of multiple audio compositions into an interpolation database. The interpolation database may therefore store large collections of interpolated variants corresponding to many different underlying works, enabling system-wide comparison, matching, and registration workflows.

Some examples of the input-handling and stem-isolation logic 705 are configured to receive audio content from the content sources 702 described above. Some examples of the input-handling and stem-isolation logic 705 support ingestion of full-mix recordings, stereo files in compressed or lossless formats, multitrack project files, individually delivered stems, legacy masters, or automated feeds delivered by authenticated application programming interfaces (APIs), webhook-triggered ingestion, scheduled synchronization with partner repositories, or catalog-pull routines. Some examples of the input-handling and stem-isolation logic 705 normalize incoming audio by decoding, converting sample rates, performing loudness normalization, channelizing audio to canonical layouts, extracting embedded metadata, verifying file integrity, and preparing the content for further analysis.

Some examples of the input-handling and stem-isolation logic 705 isolate stems when multitrack sources are not provided. Some examples of the input-handling and stem-isolation logic 705 apply one or more audio source-separation models to generate isolated vocal stems, drum stems, bass stems, harmonic stems, keyboard stems, guitar stems, effects stems, or other musical components. Some examples of the input-handling and stem-isolation logic 705 perform multi-pass separation that improves isolation quality by reducing cross-stem bleed, sharpening harmonic elements, and isolating transient material with increased accuracy.

Some examples of the variant-generation logic 710 generate pitch-shifted, key-shifted, and tempo-shifted variants for both full-mix recordings and isolated stems. Some examples of the variant-generation logic 710 generate pitch-shifted variants spanning up to two octaves above and two octaves below the original pitch, in half-step (semitone) increments. In some examples, a two-octave shift in each direction corresponds to forty-eight semitone increments; accordingly, some examples of the variant-generation logic 710 generate approximately forty-eight or forty-nine pitch-shifted versions of each full-mix recording or stem. Some examples of the variant-generation logic 710 apply tempo-adjustments in increments of approximately 3 BPM, generating twenty or more tempo-adjusted versions for each pitch-shifted level. Some examples of the variant-generation logic 710 maintain pitch constant when generating tempo-adjusted variants so that, for example, all tempo-shifted variants associated with a pitch-shifted version in the key of A remain in the key of A while varying in BPM. Some examples of the variant-generation logic 710 repeat this tempo-interpolation process for each pitch-shifted version to produce a comprehensive set of pitch-tempo combinations. Some examples of the variant-generation logic 710 generate separate pitch-tempo interpolation sets for each stem so that each isolated musical component receives a full set of interpolated versions. Some examples of the variant-generation logic 710 combine manipulated stems into composite variants to simulate mashups or derivative tracks in which only a subset of stems from the original work appear.

Some examples of the variant-generation logic 710 generate every permutation of the defined pitch-adjustment set and the defined tempo-adjustment set for each identified stem and, in some examples, for each full-mix recording. In these examples, the system computes a Cartesian combination of all semitone-based pitch adjustments and all BPM-based tempo adjustments such that, for every pitch-shift increment, the system also generates each corresponding tempo-shift increment. The result is a complete set of pitch-tempo interpolated variants for each stem and full-mix recording, providing exhaustive coverage of likely transformations that may appear in unauthorized derivative works, mashups, time-stretched edits, pitch-shifted versions, or other forms of manipulated audio content.

Some examples of the variant-management and preparation logic 715 store, manage, organize, and prepare the variants generated by the variant-generation logic 710. Some examples of the variant-management and preparation logic 715 maintain metadata describing each variant, including pitch-increment values, BPM-increment values, stem identifiers, transformation parameters, lineage records, timestamps, and workflow identifiers. Some examples of the variant-management and preparation logic 715 organize the variants into data structures suitable for downstream matching, fingerprinting, or registration workflows and prepare representative subsets for communication to infringement-analysis systems 720. Some examples of the variant-management and preparation logic 715 normalize, encode, or package variants into delivery formats compatible with fingerprinting systems, music-identification platforms, or copyright-registration services. Some examples of the variant-management and preparation logic 715 further communicate the interpolation database, or selected portions thereof, to external systems configured to perform copyright registration, audio fingerprinting, digital-rights management, content-identification processing, or any combination thereof. In some examples, the system assigns a unique audio fingerprint identifier to each interpolated variant stored in the interpolation database, enabling individualized tracking, matching, and rights enforcement for every pitch-shifted, tempo-adjusted, and stem-specific version. Each unique fingerprint may be communicated to external fingerprinting databases, collection agencies, or digital-rights management platforms, such that each interpolated variant may be independently identified, matched, and monetized when detected in user-uploaded content, streaming-platform submissions, or broadcast monitoring systems. In some examples, each unique audio fingerprint identifier comprises a hash value, alphanumeric code, or multi-dimensional feature vector derived from the audio content of the interpolated variant. An example fingerprint record may be structured as follows:

```
{
  “variant_id”: “VAR-0001”,
  “fingerprint_id”: “FP-8A3F2E9D-4B7C-11EE-BE56-0242AC120002”,
  “fingerprint_hash”: “a3f2e9d4b7c11eebe560242ac120002”,
  “audio_features”: {
    “duration_ms”: 245000,
    “sample_rate”: 44100,
    “bit_depth”: 16,
    “format”: “WAV”
  },
  “variant_parameters”: {
    “semitone_shift”: “+1”,
    “bpm_adjustment”: “0”,
    “stem_type”: “full_mix”
  },
  “submission_targets”: [“Shazam”, “YouTube_ContentID”, “SoundCloud”],
  “timestamp”: “2025-12-15T10:30:00Z”
}
```

In some examples, the system maintains a fingerprint registry associating each variant identifier with its corresponding fingerprint data, enabling rapid lookup and matching operations. In some examples, the fingerprint identifier is generated using audio fingerprinting algorithms such as spectral peak analysis, mel-frequency cepstral coefficients (MFCC), chromogram analysis, or other acoustic feature extraction techniques known in the art.

In some examples, the system may prepare the interpolation database, or selected subsets thereof, for submission as a collaborative work, compilation, or collective work under copyright law. By treating multiple interpolated variants—potentially spanning one or more underlying compositions—as elements of a single collaborative work or compilation, the system may enable cost-effective registration strategies that maximize coverage of pitch-shifted, tempo-adjusted, and stem-specific variants while reducing per-work filing costs associated with individual copyright registrations. In some examples, the system generates a registration bundle comprising: (i) metadata records identifying each interpolated variant by title, unique identifier (such as ISRC, UPC, or system-generated identifier), authorship or claimant information, derivation source (the underlying original composition), and technical parameters (such as semitone shift value, BPM adjustment value, and stem identity); (ii) a manifest file or index (such as an XML file, JSON file, CSV spreadsheet, or database export) organizing the metadata records in a hierarchical or relational structure suitable for batch submission; (iii) deposit copies of selected interpolated variants, which may be provided as audio files in formats such as WAV, MP3, FLAC, or other formats accepted by the registration authority; and (iv) documentation describing the interpolation methodology, the collaborative or compilation nature of the work, and the relationship between the interpolated variants and the underlying original composition or compositions. In some examples, the registration bundle is communicated electronically to copyright registration authorities such as the U.S. Copyright Office (for example, via the eCO electronic registration system or bulk-upload interfaces), the Library of Congress, or equivalent national or international copyright registration agencies. In some examples, the collaborative work comprises interpolated variants derived from a single original composition; in other examples, the collaborative work comprises interpolated variants derived from multiple compositions held in a common catalog or portfolio.

In some examples, the registration bundle may comprise a directory or file-system hierarchy containing: a manifest file (such as “manifest.json”) providing an index of all interpolated variants included in the bundle; a metadata file (such as “metadata.csv”) providing detailed variant information in tabular format; methodology documentation (such as a PDF file) explaining the interpolation process and collaborative-work structure; and a deposit-copies directory containing audio files for each interpolated variant. An example manifest file may be structured as follows:

```
{
  “registration_type”: “collaborative_work”,
  “registration_title”: “Interpolated Variants Collection - 2025 Q4”,
  “claimant”: “ABC Music Publishing”,
  “variants”: [{
    “variant_id”: “VAR-0001”,
    “original_title”: “Song Title”,
    “original_isrc”: “USXXX2012345”,
    “semitone_shift”: “+1”,
    “bpm_adjustment”: “0”,
    “stem_type”: “full_mix”,
    “filename”: “song_001_plus1semitone_Asharp_120bpm.wav”
  },{
    “variant_id”: “VAR-0002”,
    “original_title”: “Song Title”,
    “original_isrc”: “USXXX2012345”,
    “semitone_shift”: “+1”,
    “bpm_adjustment”: “+3”,
    “stem_type”: “full_mix”,
    “filename”: “song_001_plus1semitone_Asharp_123bpm.wav”
  }]
}
```

An example metadata file in CSV format may be structured as follows:
Variant_ID, Original_Title, Original_ISRC, Semitone_Shift, BPM_Adjustment, Stem_Type, File name
VAR-0001,Song
Title, USXXX2012345,+1,0,full_mix, song_001_plus1semitone_Asharp_120bpm.wav
VAR-0002,Song
Title, USXXX2012345,+1,+3,full_mix, song_001_plus1semitone_Asharp_123bpm.wav
VAR-0003,Song
Title, USXXX2012345,+1,+6,full_mix, song_001_plus1semitone_Asharp_126bpm.wav
VAR-0004,Song
Title, USXXX2012345,+2,0,full_mix, song_001_plus2semitones_B_120bpm.wav

In some examples, each row in the metadata file corresponds to one interpolated variant, and each variant is associated with: a unique variant identifier; the title and ISRC code of the underlying original composition; numerical values indicating the semitone shift and BPM adjustment applied; a stem-type identifier (such as “full_mix,” “vocal_stem,” “drum_stem,” “bass_stem,” or “harmonic_stem”); and a filename referencing the corresponding audio file in the deposit-copies directory. In some examples, the manifest file and metadata file are generated automatically by the system based on the contents of the interpolation database, ensuring consistency between the stored variants and the registration materials. In some examples, the system communicates the registration bundle electronically to the copyright registration authority via file-transfer protocols (such as FTP, SFTP, or HTTPS upload), web-service APIs, or portal-based upload interfaces provided by the registration authority.

Some examples of the variant-management and preparation logic 715 store, for each audio composition, data representing a matrix that organizes the interpolated variants according to transformation parameters. In some examples, the matrix defines axes corresponding to pitch adjustments 712A, stem identity 712B, and tempo adjustments 712C, such that each interpolated variant is indexed by a semitone-shift value, a stem identifier, and a BPM-adjustment value. This multidimensional structure enables efficient retrieval of variants for downstream matching, fingerprinting, or registration workflows and supports rapid access to all pitch-tempo permutations generated for each identified stem.

FIG. 8 illustrates example infringement-analysis logic 800. The infringement-analysis logic 800 includes content-submission logic 805, comparison logic 810, and action logic 815. The infringement-analysis logic 800 receives audio variants communicated by the audio-variant generation and organization logic 700 and also receives a suspect audio submission 401, such as a creator-uploaded track, an attempted upload to a content-sharing system, or other audio content to be checked for infringement. The infringement-analysis logic 800 compares the suspect audio submission 401 to the variants generated by the audio-variant generation and organization logic 700 and determines an appropriate action to take—such as reporting match outcomes, determining whether an upload should be permitted, or preparing rights-registration information.

Some examples of the content-submission logic 805 prepare and submit variants or suspect content to external music-identification, digital-rights, or fingerprinting systems using authenticated APIs. Some examples of the content-submission logic 805 manage queueing, batching, rate-limiting, delivery guarantees, and retry workflows when communicating both full-mix and stem-specific variants. Some examples of the content-submission logic 805 receive comparison outputs such as match results, similarity scores, fingerprint hashes, alignment offsets, and other metadata provided by external systems.

Some examples of the comparison logic 810 analyze the comparison results returned by external systems to determine whether the suspect audio submission 401 matches any of the variants supplied by the audio-variant generation and organization logic 700. Some examples of the comparison logic 810 evaluate similarity strength, harmonic correlation, fingerprint density, temporal alignment, and other match indicators. Some examples of the comparison logic 810 determine whether additional evaluation is required, including whether stem-level comparison should be performed, whether additional variants should be submitted, or whether partial reuse is detected consistent with mashups, sampled beats, layered composites, or hybrid derivative tracks.

Some examples of the action logic 815 determine the action to take in response to the comparison results. Some examples of the action logic 815 report match outcomes, block or allow an upload, prepare a registration bundle, initiate a rights-management workflow, transmit notifications to rights holders, or update internal or external rights-tracking systems. Some examples of the action logic 815 maintain policies regarding when matches constitute probable infringement, when additional verification is required, and when stem-level matches indicate multi-work infringement due to the presence of stems from multiple copyrighted recordings. Some examples of the action logic 815 further block distribution, streaming, publishing, or other dissemination of the suspect content when a match indicates likely infringement.

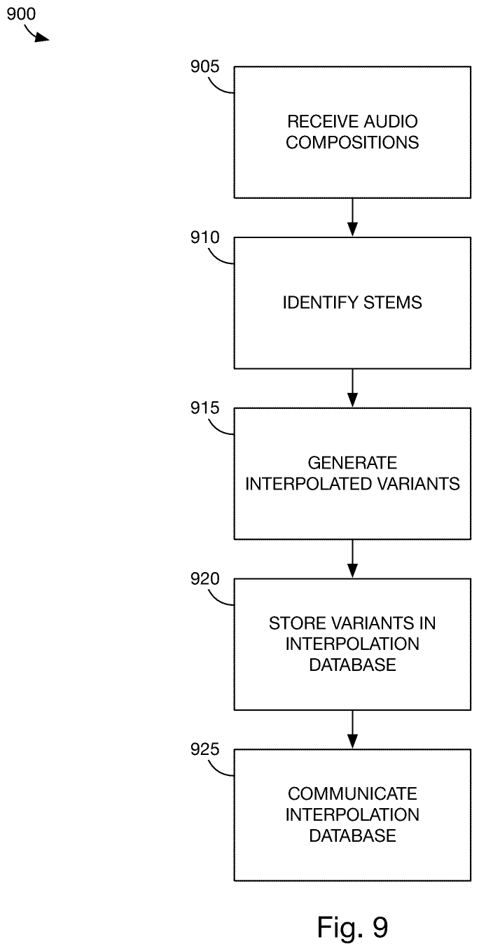

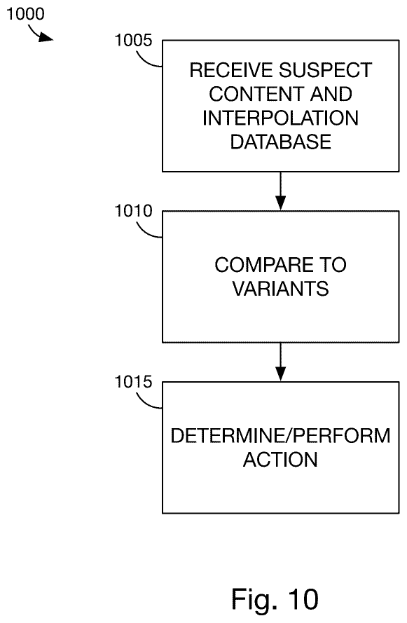

FIGS. 9 and 10 illustrate example operations that may be performed by a system configured to generate interpolated variants for a plurality of audio compositions and to compare suspect content against those variants for infringement analysis. In some examples, the operations of FIGS. 9 and 10 are performed by a single integrated system that implements both the audio-variant generation and organization logic 700 and the infringement-analysis logic 800. In other examples, the operations of FIG. 9 are performed by a first system that generates and manages the interpolation database, while the operations of FIG. 10 are performed by a second system that receives the interpolation database and performs infringement analysis. The operations may be implemented by instruction code stored in one or more instruction-storage devices and executed by one or more processors of the associated system or systems.

FIG. 9 illustrates example operations 900 for generating interpolated variants of a plurality of audio compositions and preparing those variants for downstream processing. The operations at block 905 involve the system receiving audio compositions from one or more content sources. In some examples, the system receives creator-submitted uploads, distribution-platform feeds, multitrack delivery bundles, partner-platform ingestion data, or catalog-synchronization inputs. In some examples, the system normalizes incoming audio formats, validates integrity, and performs initial metadata extraction.

The operations at block 910 involve the system identifying stems of each audio composition. In some examples, the system identifies stems based on stem information delivered with multitrack or multichannel audio. In other examples, the system extracts stems using one or more machine-learning source-separation models capable of isolating vocals, drums, bass, harmonic layers, keyboards, guitars, effects, or other musical components. In some examples, the system performs multi-pass separation to improve isolation accuracy and reduce cross-stem bleed.

The operations at block 915 involve the system generating interpolated variants for the identified stems and, in some examples, for full-mix versions of the audio compositions. In some examples, the system applies semitone-based pitch adjustments spanning up to two octaves above and below an original pitch and applies tempo adjustments in increments of approximately 3 BPM. In some examples, the system generates every permutation of the pitch-adjustment set and tempo-adjustment set, producing a complete Cartesian combination of pitch-tempo variants for each identified stem and, optionally, each full mix. In some examples, these interpolated variants simulate transformations typically found in unauthorized derivative works, mashups, sampled-beat compositions, time-stretched edits, pitch-shifted copies, or other manipulated audio content.

The operations at block 920 involve the system storing the interpolated variants in an interpolation database. In some examples, the interpolation database includes variants for a plurality of audio compositions and maintains metadata describing each variant, including pitch increments, tempo increments, stem identifiers, transformation parameters, lineage information, and timestamps. In some examples, the system organizes the variants for a given audio composition into a multidimensional matrix defining axes corresponding to semitone shifts, BPM adjustments, and stem identity, enabling efficient indexing and retrieval for later comparison, matching, or registration workflows.

In some examples, the interpolation database scales to accommodate large catalogs comprising thousands to millions of audio compositions. For example, generating a complete set of pitch-shifted, tempo-adjusted, and stem-specific variants for a single audio composition may result in data storage requirements approaching or exceeding one terabyte per composition, depending on the number of identified stems, the range of pitch and tempo adjustments, the audio quality and bit depth of the stored variants, and whether lossless or compressed encoding is employed. In some examples, the system is configured to manage interpolation databases comprising variants for at least one thousand compositions, at least one hundred thousand compositions, at least one million compositions, or at least ten million compositions, enabling deployment for individual artists, independent record labels, music publishers, performing rights organizations, or major-catalog rights holders managing extensive musical portfolios. In some examples, the data storage requirements may be calculated as follows: for a single audio composition having five identified stems (vocal, drum, bass, harmonic, and effects), with forty-eight pitch-shifted versions per stem, and twenty tempo-adjusted variants per pitch level, the total number of interpolated variants may approach or exceed 4,800 variants per stem, or approximately 24,000 total variants across all stems. If each variant is stored as an uncompressed WAV file at CD quality (44.1 kHz sample rate, 16-bit depth, stereo), and the average composition duration is four minutes, each variant may require approximately 40-50 megabytes of storage, resulting in aggregate storage requirements of approximately 960 gigabytes to 1.2 terabytes per composition. In some examples, the system employs lossless or lossy compression (such as FLAC, ALAC, or high-bitrate MP3 encoding) to reduce per-variant storage requirements by a factor of two to ten, enabling more efficient storage and transmission while preserving audio fidelity sufficient for fingerprinting and rights-enforcement purposes. In some examples, the system is deployed on cloud-based storage infrastructure, distributed file systems, or dedicated data-center facilities configured to manage petabyte-scale or exabyte-scale data volumes for catalogs comprising hundreds of thousands to millions of compositions.

The operations at block 925 involve the system communicating the interpolation database, or selected portions thereof, to one or more external or downstream systems. In some examples, the system communicates the interpolation database to an infringement-analysis system such as the infringement-analysis logic 800 of FIG. 8. In other examples, the system communicates the data to fingerprinting engines, copyright-registration platforms, digital-rights management systems, music-identification platforms, or other content-identification or rights-processing systems. In some examples, the system normalizes, packages, or encodes the data for delivery, and manages transmission using authenticated APIs, queueing, rate-limiting, batching, or retry workflows.

FIG. 10 illustrates example operations 1000 for performing infringement analysis using the interpolation database and suspect content. The operations at block 1005 involve the system receiving suspect content to be evaluated for infringement together with the interpolation database or a selected portion of the interpolation database. In some examples, the suspect content corresponds to a user-uploaded audio track, a streaming-platform upload attempt, or another piece of content provided for rights verification. In some examples, the interpolation database is received from the system performing the operations of FIG. 9.

The operations at block 1010 involve the system comparing the suspect content to the interpolated variants stored in, or communicated from, the interpolation database. In some examples, the system evaluates similarity strength, harmonic correlation, fingerprint density, temporal alignment, spectral characteristics, or other comparison features. In some examples, the system performs stem-level comparison, full-mix comparison, or multi-stage comparison to detect partial reuse, stem reuse, mashups, layered composites, or hybrid derivative tracks. In some examples, the system submits suspect content or selected variants to external fingerprinting or music-identification services and processes the similarity scores, match signals, alignment offsets, or fingerprint hashes returned.

The operations at block 1015 involve the system determining—and optionally performing—an action based on the comparison results. In some examples, the system reports match outcomes, blocks or permits dissemination of the suspect content, prepares or updates rights-registration bundles, or initiates rights-management workflows. In some examples, the system transmits notifications to rights holders, updates internal or external rights-tracking systems, or determines whether additional verification is required. In some examples, the system identifies multi-work infringement when stems from multiple copyrighted compositions are detected in the suspect content.

Although FIGS. 9 and 10 are illustrated separately for clarity, the operations depicted therein may be performed in any suitable order and by systems that are separate, partially integrated, or fully integrated. In some examples, the system performing the operations of FIG. 9 and the system performing the operations of FIG. 10 exchange information through authenticated APIs, shared data repositories, message queues, streaming data interfaces, or other communication mechanisms.

Additional, fewer, or alternative operations may be implemented without departing from the scope of the present disclosure. The illustrated operations represent examples only and are not intended to limit the order, combination, or distribution of operations across hardware, software, or hybrid implementations.

Blocks of the flowcharts of FIGS. 5, 6, 9, and 10 support combinations of means for performing the specified functions and combinations of operations for performing the specified functions. It will also be understood that one or more blocks of the flowcharts depicted in these figures, and combinations of such blocks, can be implemented by special purpose hardware-based computer systems which perform the specified functions, or combinations of special purpose hardware and computer instructions. Also, more, fewer or different steps may be provided.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device of an apparatus employing an aspect of the present invention and executed by the processing circuitry. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

Many modifications and other aspects of the inventions set forth herein will come to mind to one skilled in the art to which these inventions pertain having the benefit of the teachings presented in the foregoing descriptions and the associated drawings. Therefore, it is to be understood that the inventions are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
one or more processors; and
one or more memories having stored thereon instruction code that, when executed by the one or more processors, causes the system to perform operations comprising:
receiving, from one or more content sources, audio content comprising a plurality of audio compositions;
for each audio composition of the plurality of audio compositions:
identifying one or more stems of the audio composition, the stems comprising individual instrument or vocal components of the audio composition; and
generating, for the audio composition and for the one or more identified stems, a plurality of interpolated stem variants by applying a set of pitch adjustments and a set of tempo adjustments;
storing the plurality of interpolated variants generated for the plurality of audio compositions in an interpolation database;
receiving suspect content for infringement analysis;
comparing the suspect content to at least a portion of the plurality of interpolated variants stored in the interpolation database to determine whether the suspect content matches one or more of the interpolated variants; and
determining an action to take based on the match, the action comprising reporting a match outcome, permitting or blocking distribution of the suspect content, or preparing material for rights registration.

2. The system of claim 1, wherein execution of the instruction code for generating the plurality of interpolated stem variants causes the system to perform operations comprising:
generating every permutation of the set of pitch adjustments and the set of tempo adjustments for each identified stem.

3. The system of claim 1, wherein execution of the instruction code for generating pitch and tempo adjustments causes the system to perform operations comprising:
generating a set of pitch adjustments comprising semitone increments spanning up to two octaves above and two octaves below an original pitch of the audio composition; and
generating a set of tempo adjustments comprising beats-per-minute adjustments in increments of approximately 3 BPM applied as increases and decreases relative to a source tempo.

4. The system of claim 3, wherein execution of the instruction code for generating the plurality of interpolated stem variants causes the system to perform operations comprising:
producing approximately forty-eight or forty-nine pitch-shifted versions for each stem; and
producing twenty or more tempo-adjusted variants for each pitch-shifted version of each stem.

5. The system of claim 1, wherein execution of the instruction code for identifying one or more stems causes the system to perform operations comprising:
identifying the one or more stems based on stem information supplied as part of the audio composition.

6. The system of claim 1, wherein execution of the instruction code for identifying one or more stems causes the system to perform operations comprising:
extracting the one or more stems using one or more machine-learning source-separation models.

7. The system of claim 1, wherein execution of the instruction code for handling the interpolation database causes the system to perform operations comprising:
communicating at least a portion of the interpolation database to one or more external systems configured to respectively perform copyright registration of the audio compositions or derivative variants, audio fingerprinting, digital-rights management, or content-identification processing, or any combination thereof.

8. A non-transitory computer-readable storage medium having stored thereon instruction code that, when executed by one or more processors, causes a system to perform operations comprising:
receiving, from one or more content sources, audio content comprising a plurality of audio compositions;
for each audio composition of the plurality of audio compositions:
identifying one or more stems of the audio composition, the stems comprising individual instrument or vocal components of the audio composition;
and generating, for the audio composition and for the one or more identified stems, a plurality of interpolated stem variants by applying a set of pitch adjustments and a set of tempo adjustments;
storing the plurality of interpolated variants generated for the plurality of audio compositions in an interpolation database;
receiving suspect content for infringement analysis;
comparing the suspect content to at least a portion of the plurality of interpolated variants stored in the interpolation database to determine whether the suspect content matches one or more of the interpolated variants; and
determining an action to take based on the match, the action comprising reporting a match outcome, permitting or blocking distribution of the suspect content, or preparing material for rights registration.

9. The non-transitory computer-readable storage medium of claim 8, wherein the instruction code, when executed, causes the system to perform operations comprising:
generating every permutation of the set of pitch adjustments and the set of tempo adjustments for each identified stem.

10. The non-transitory computer-readable storage medium of claim 8, wherein the instruction code, when executed, causes the system to perform operations comprising:
generating a set of pitch adjustments comprising semitone increments spanning up to two octaves above and two octaves below an original pitch of the audio composition; and
generating a set of tempo adjustments comprising beats-per-minute adjustments in increments of approximately 3 BPM applied as increases and decreases relative to a source tempo.

11. The non-transitory computer-readable storage medium of claim 8, wherein the instruction code, when executed, causes the system to perform operations comprising:
producing approximately forty-eight or forty-nine pitch-shifted versions for each stem; and
producing twenty or more tempo-adjusted variants for each pitch-shifted version of each stem.

12. The non-transitory computer-readable storage medium of claim 8, wherein the instruction code, when executed, causes the system to perform operations comprising:
identifying the one or more stems based on stem information supplied as part of the audio composition.

13. The non-transitory computer-readable storage medium of claim 8, wherein the instruction code, when executed, causes the system to perform operations comprising:
extracting the one or more stems using one or more machine-learning source-separation models.

14. The non-transitory computer-readable storage medium of claim 8, wherein the instruction code, when executed, causes the system to perform operations comprising:
organizing the interpolated variants into a multidimensional matrix that indexes each interpolated variant by semitone-increment values, BPM-increment values, and stem identifiers.

15. The non-transitory computer-readable storage medium of claim 8, wherein the instruction code, when executed, causes the system to perform operations comprising:
communicating at least a portion of the interpolation database to one or more external systems configured to respectively perform copyright registration of the audio compositions or derivative variants, audio fingerprinting, digital-rights management, content-identification processing, or any combination thereof.

16. A method comprising:
receiving, from one or more content sources, audio content comprising a plurality of audio compositions;
for each audio composition of the plurality of audio compositions:
identifying one or more stems of the audio composition, the stems comprising individual instrument or vocal components of the audio composition; and
generating, for the audio composition and for the one or more identified stems, a plurality of interpolated stem variants by applying a set of pitch adjustments and a set of tempo adjustments;
storing the plurality of interpolated variants generated for the plurality of audio compositions in an interpolation database;
receiving suspect content for infringement analysis;
comparing the suspect content to at least a portion of the plurality of interpolated variants stored in the interpolation database to determine whether the suspect content matches one or more of the interpolated variants;
and determining an action to take based on the match, the action comprising reporting a match outcome, permitting or blocking distribution of the suspect content, or preparing material for rights registration.

17. The method of claim 16, comprising:
generating every permutation of the set of pitch adjustments and the set of tempo adjustments for each identified stem.

18. The method of claim 16, comprising:
generating a set of pitch adjustments comprising semitone increments spanning up to two octaves above and two octaves below an original pitch of the audio composition; and
generating a set of tempo adjustments comprising beats-per-minute adjustments in increments of approximately 3 BPM applied as increases and decreases relative to a source tempo.

19. The method of claim 16, comprising:
producing approximately forty-eight or forty-nine pitch-shifted versions for each stem; and
producing twenty or more tempo-adjusted variants for each pitch-shifted version of each stem.

20. The method of claim 16, comprising:
extracting the one or more stems using one or more machine-learning source-separation models.
